(19) United States
(12) Patent Application Publication
(10) Pub. No.: US 2004/0111243 A1
(43) Pub. Date: Jun. 10, 2004

(54) Analytical model conversion method

(75) Inventor: Kaoru Okitaka, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/698,556

(22) Filed: Nov. 3, 2003

(30) Foreign Application Priority Data
Nov. 6, 2002 (JP) 2002-322206

(51) Int. Cl. G06F 17/10

(52) U.S. Cl. 703/2

(57) ABSTRACT

This present invention relates to a method of creating a shell element analytical model for two-dimensional analysis from a three-dimensional solid analytical model by a finite element method on the basis of three-dimensional geometric data designed by three-dimensional CAD. An analytical model conversion method of this invention is an analytical model conversion method of converting a three-dimensional analytical model into a two-dimensional analytical model, which includes generating tetrahedral solid elements for an input three-dimensional geometric model, and connecting the intermediate nodes of sides that extend in the direction of plate thickness in each solid element to generate a triangular or rectangular shell element.

### FIELD OF THE INVENTION

The present invention relates to a method of creating a shell element analytical model for two-dimensional analysis from a three-dimensional solid analytical model by a finite element method on the basis of three-dimensional geometric data designed by three-dimensional CAD.

### BACKGROUND OF THE INVENTION

As three-dimensional CAD is recently becoming popular, preparation of a quick analytical model creating method using three-dimensional CAD geometric data has been demanded. As is represented by linear structure analysis, a three-dimensional solid analytical model can be created by tetrahedral element division by a finite element method based on three-dimensional CAD geometric data so that analysis can easily be executed.

However, if thin-walled structures or exterior components are to be analyzed by using three-dimensional solid analytical models, as in, e.g., plastic injection molding CAE (filling/packing/cooling/warp analysis program), the temperature distribution in the direction of plate thickness must be accurately calculated. To do this, element division in the direction of plate thickness in about five to 10 layers is necessary. At this time, the total number of elements of analytical models is more than 5,000,000. It is not practical in terms of calculation cost from the viewpoint of current computing capability. In many cases, therefore, a neutral plane is created manually from a three-dimensional solid model. Calculation is performed by using an analytical model obtained by dividing the neutral plane by triangular or rectangular two-dimensional shell elements.

Examples of prior arts of the neutral plane and neutral plane element generation method are as follows.

1) Method of generating a neutral plane in the direction of plane thickness of a three-dimensional solid geometric model

Two-dimensional neutral plane surface data is manually generated for two planes that constitute the plane thickness of geometric data from three-dimensional solid CAD data. A neutral plane can be generated by using a CAD/CAE tool represented by, e.g., IDEAS, PATRAN, and FEMAP. There also exists a method of generating a two-dimensional shell element model for the neutral plane shape.

2) Method of generating a hexahedral solid element and generating a two-dimensional shell element by using an intermediate node

In a method of prior art, a hexahedral solid element is generated from three-dimensional solid CAD data by using a preprocessor such as a finite element method, and a shell element is generated by using an intermediate node.

However, the above-described neutral plane and neutral plane element generation methods have the following problems.

1) Method of generating two-dimensional neutral plane surface data from three-dimensional solid CAD data

It is difficult to accurately generate a neutral plane for a portion where planes cross each other, a portion where the plate thickness changes, or a thick-walled portion. In addition, no plate thickness information can be added to the generated neutral plane surface even when the plate thickness changes in a tapered manner. Hence, plate thickness information must be manually input after element division.

2) Method of generating a hexahedral solid element and generating a two-dimensional shell element by using an intermediate node

A hexahedral solid element is hard to automatically generate even by using a preprocessor. A hexahedral solid element needs to be manually generated. Model creation is therefore very time-consuming.

As described above, in both the method of generating a neutral plane in the direction of plane thickness of a three-dimensional solid geometric model and generating a two-dimensional shell element model for the neutral plane shape and the method of generating a hexahedral solid element in a three-dimensional solid geometric model and generating a two-dimensional shell element by using an intermediate node, analytical model creation is very time-consuming.

### SUMMARY OF THE INVENTION

The present invention relates to a method of automatically creating a two-dimensional shell element analytical model on the basis of three-dimensional CAD geometric data. It is therefore a feature of the present invention to largely shorten the time for creation of a two-dimensional shell element analytical model from three-dimensional CAD geometric data.

According to the present invention, there is provided an analytical model conversion method of converting a three-dimensional analytical model into a two-dimensional analytical model, comprising generating tetrahedral solid elements for an input three-dimensional geometric model, and connecting intermediate nodes of sides that extend in a direction of plate thickness in each tetrahedral solid element to generate a triangular or rectangular shell element.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a flow chart showing the outline of a neutral plane element generation method;

FIG. 2 is a view showing a case wherein a triangular neutral plane element is generated in a tetrahedral element;

FIG. 3 is a view showing a case wherein a rectangular neutral plane element is generated in a tetrahedral element;

FIG. 4 is a view showing an example of tetrahedral element division of a shape having a plate thickness difference;

FIG. 5 is a view showing another example of tetrahedral element division of a shape having a plate thickness difference;

FIG. 6 is a view showing an example of tetrahedral element division of a rib shape;

FIG. 7 is a view showing another example of tetrahedral element division of a rib shape;

FIG. 8 is a view showing still another example of tetrahedral element division of a rib shape;

FIG. 9 is a view showing an example of tetrahedral element division of an L shape;

FIG. 10 is a view showing another example of tetrahedral element division of an L shape;

FIG. 11 is a view showing an example of tetrahedral element division of a cross shape;

FIG. 12 is a view showing an example of tetrahedral element division of a shape having crossing radial portions;

FIG. 13 is a flow chart showing details of the neutral plane element generation method;

FIG. 14 is a view showing the three-dimensional CAD geometry of a component of a fixing toner container used in a laser beam printer (LBP), which is designed by IDEAS;

FIG. 15 is a view showing the three-dimensional CAD geometry of a component of a fixing toner container used in a laser beam printer (LBP), which is designed by IDEAS;

FIG. 16 is a view showing divided elements obtained by automatically dividing the three-dimensional CAD geometric data into tetrahedral elements by using a preprocessor function for finite element analysis of IDEAS so as to form a single-layered structure in the direction of plate thickness; and

FIG. 17 is a view showing a shell element model for which neutral plane shell elements are generated from the tetrahedral elements on the basis of a neutral plane element division method.

FIG. 18 is a block diagram showing the construction of a terminal which runs a system for simulating the conveyance of the medium according to the first embodiment.

### DETAILED DESCRIPTION OF THE PREFERRED EMBODIMENT

As described above, the present invention relates to a method of automatically creating a two-dimensional shell element analytical model on the basis of three-dimensional CAD geometric data. With this method, time for creation of a two-dimensional shell element analytical model from three-dimensional CAD geometric data can largely be shortened. The embodiment of the present invention will be described below in detail with reference to the accompanying drawings.

### Embodiment

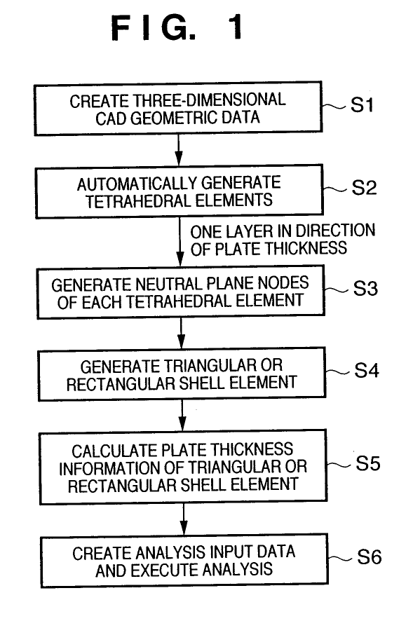

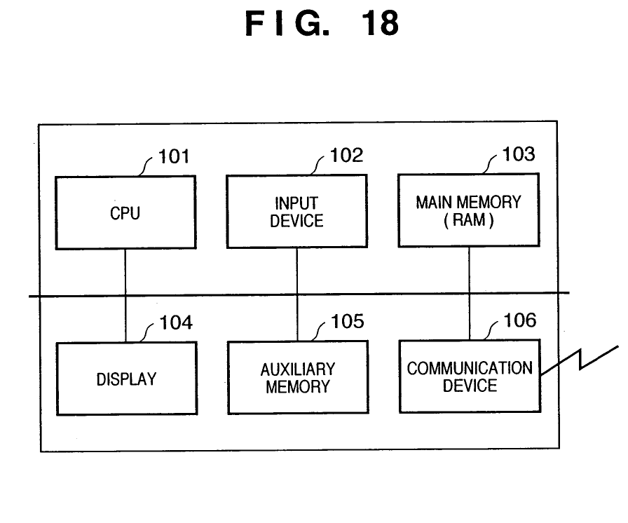

FIG. 1 shows one schematic process of an apparatus of the present invention. FIG. 18 is a block diagram showing the construction of the apparatus of an embodiment of the present invention.

A central processing unit (CPU) 101 performs the overall control of the terminal on the basis of programs expanded in a main memory 103. An input device 102 is a pointing device including a key board, a mouse, etc. The main memory 103 is constructed of a random access memory (RAM) or the like and serves as a work memory for, for example, expanding the programs. A display 104 is constructed of a cathode-ray tube (CRT) monitor, a liquid crystal display, or the like. An auxiliary memory 105 is constructed of a hard disk drive or the like and stores various programs for operating a server (or the terminal) and various databases. A communication device 106 is an interface for providing connection to a network.

First, as shown in step S1 in FIG. 1, assume that an object shape is designed by three-dimensional CAD so that three-dimensional CAD geometric data is available. Processing starts from a state wherein the three-dimensional geometric data is loaded by a preprocessor such as IDEAS available from EDS PLM solutions or PATRAN available from MSC, which is used for finite element analysis and is capable of tetrahedral element division.

In step S2 in FIG. 1, tetrahedral elements are generated from the shape by using the automatic tetrahedral element division function of the preprocessor. At this time, the length of one side of each tetrahedral element must be designated such that the shape is divided in the direction of plate thickness to form a single-layered structure. This can be done by designating the maximum plate thickness of the shape. The node coordinate information and element constituent node information of the tetrahedral elements generated by element division are written in external files. If the shape has a thick-walled portion, and the number of layers in the direction of plate thickness should be two or more, the shape is corrected in advance on the three-dimensional CAD side.

In step S3 in FIG. 1, on the basis of the node coordinate information and element constituent node information of the tetrahedral elements generated in step S2, an intermediate node is generated in each of sides that constitute a tetrahedral element. This processing may be executed even by designating secondary tetrahedral elements (tetrahedrons having an intermediate node in each side) in automatic tetrahedral element division in step S2.

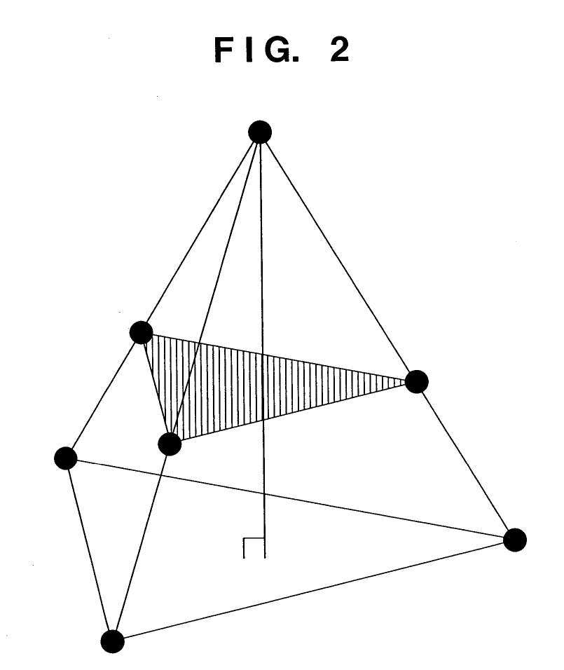

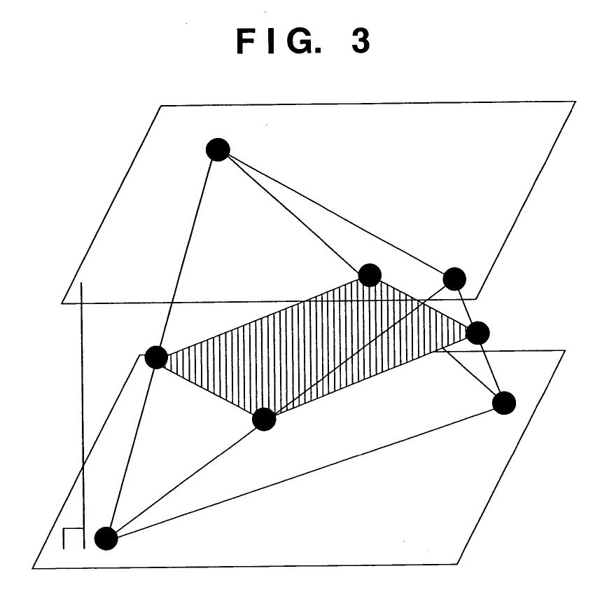

In step S4 in FIG. 1, triangular or rectangular neutral plane shell elements are generated in the direction of plate thickness of the shape by using the intermediate node information in step S3. When the tetrahedral elements are generated such that the number of layers formed by dividing the shape in the direction of plate thickness becomes one, a tetrahedral element generated between the upper and lower planes in the direction of plate thickness can basically take two forms. As the first form, a plane and a corresponding apex of the tetrahedral element are located on the upper and lower planes of the shape, as shown in FIG. 2. As the second form, two sides of the tetrahedral element are located on the upper and lower planes of the shape, as shown in FIG. 3. The neutral plane shell element is triangular in the former case and rectangular in the latter case.

In step S5 in FIG. 1, for each of the triangular or rectangular neutral plane shell elements generated in step S4, the plate thickness until the geometric surface in the direction of normal of the neutral plane shell element is calculated and defined as the plate thickness of the shell element.

Finally, in step S6 in FIG. 1, analysis input data is created by adding boundary conditions or analysis conditions corresponding to the type of analysis to the node coordinates, element constituent node, and element plate thickness information of the triangular or rectangular shell elements generated in accordance with the above-described procedures. Then, analysis is executed.

The basic outline until analysis input data is created by generating neutral plane shell elements from a three-dimensional shape has been described above.

The processing must cope with the geometric elements of an actual complex product shape. A method for it will be described in detail.

Tetrahedral element generation patterns and neutral plane shell element generation methods will be described in consideration of geometric elements having plate thickness differences or rib structures of various types.

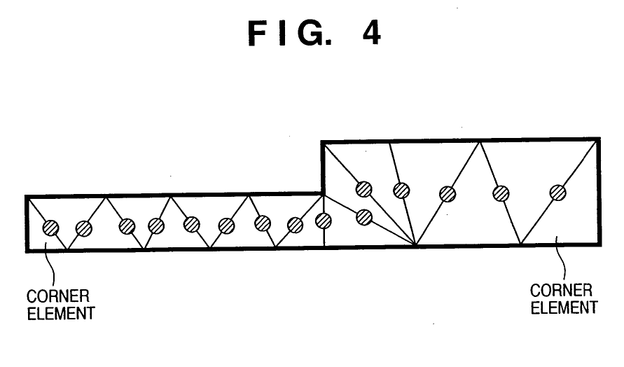

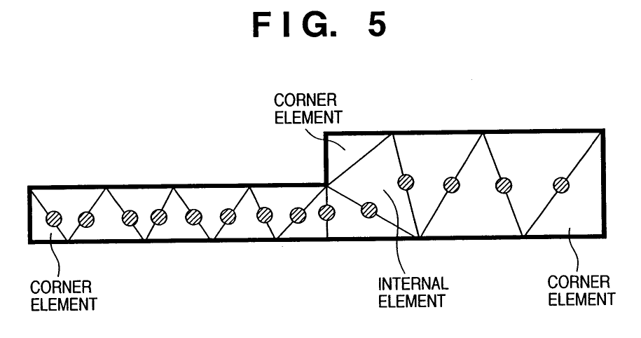

FIGS. 4 and 5 show tetrahedral element generation patterns when a shape has a plate thickness difference on the geometric section in the direction of plate thickness. Basically, each corner portion of the shape has a tetrahedral element whose two or more element planes are located on the outer surface of the shape, as shown in FIGS. 4 and 5. This element will be referred to as a “corner element”. The “corner element” (FIG. 5) at the plate step portion can be excluded. However, a “corner element” at an end portion of the shape cannot be omitted. Hence, the two types of corner elements must be distinguished.

In addition, a tetrahedral element (FIG. 5) whose element planes are not located on the outer surface of the shape at all is formed. This element will be referred to as an “internal element”. To generate a neutral plane shell element in this “internal element”, the constituent nodes of the neutral plane shell elements in adjacent tetrahedral elements and their continuity must be taken into consideration.

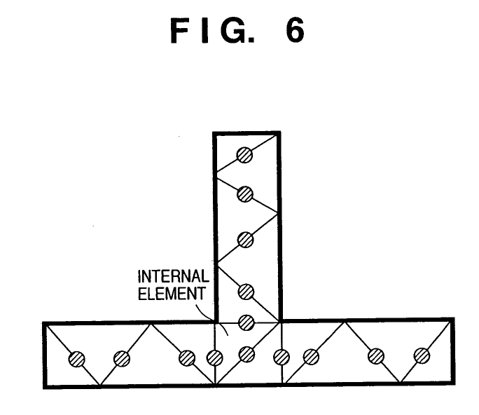

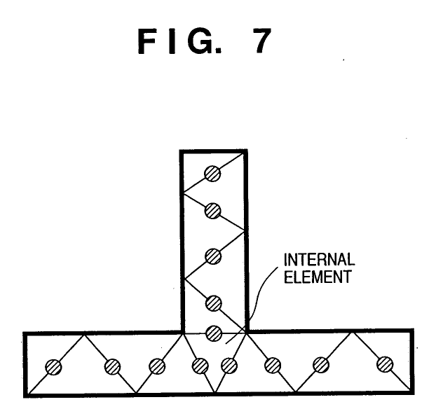

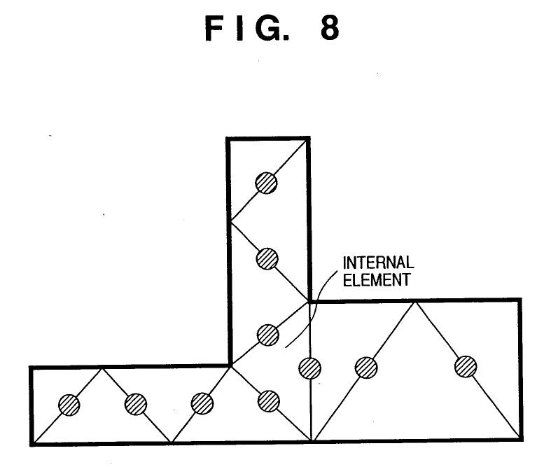

FIGS. 6, 7, and 8 show tetrahedral element generation patterns when a shape has a T-shaped section because of addition of a rib. Even in these examples, a tetrahedral element as an “internal element” whose element planes are not located on the outer surface of the shape at all is generated. Hence, a shell element must be generated in consideration of the constituent nodes of the neutral plane shell elements in adjacent tetrahedral elements and their continuity.

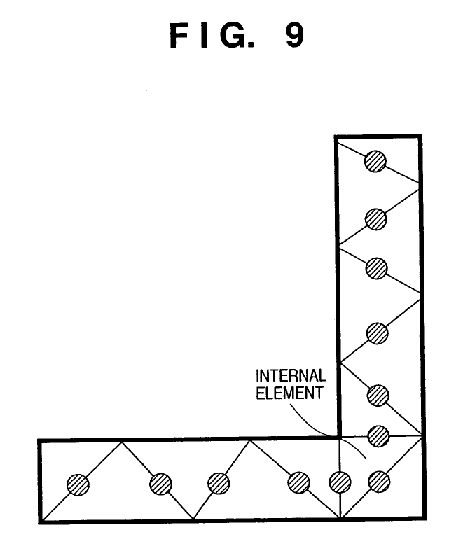

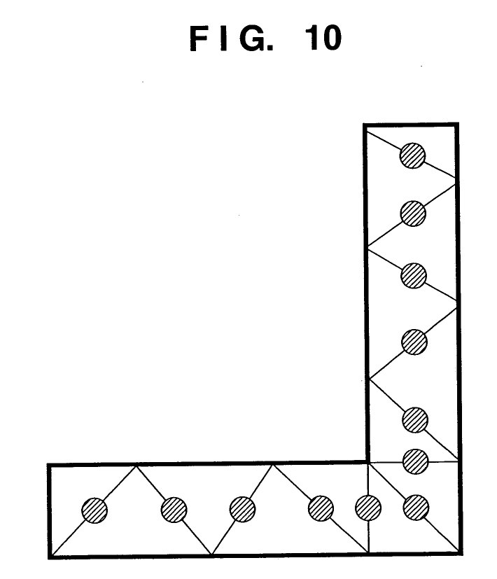

FIGS. 9 and 10 show tetrahedral element generation patterns when a shape has an L-shaped section. Even in these examples, “corner elements” and “internal elements” are generated.

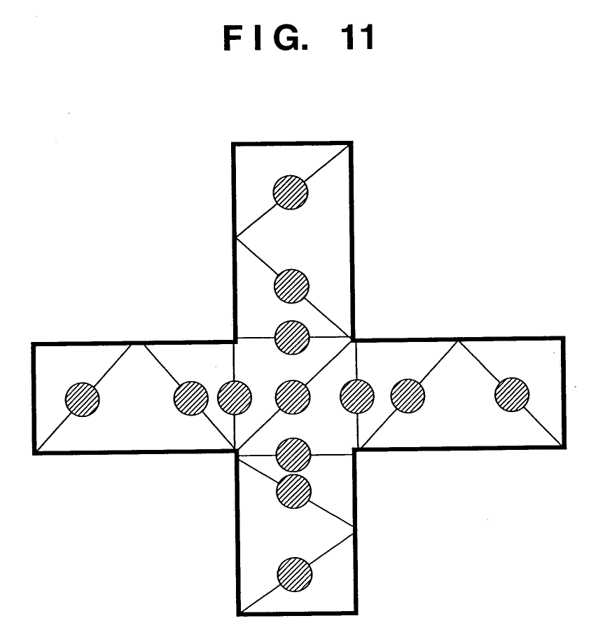

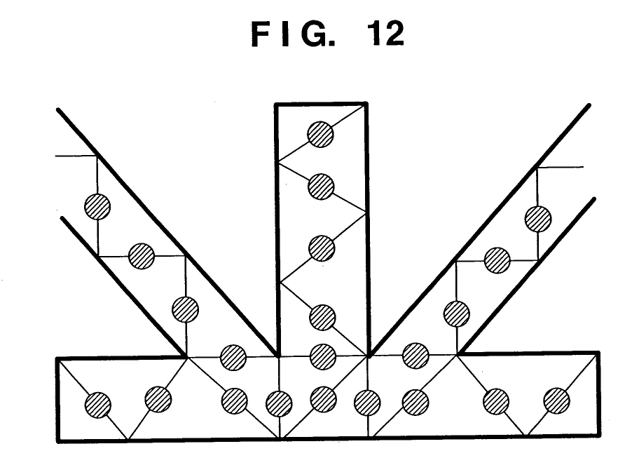

FIGS. 11 and 12 show tetrahedral element generation patterns when a shape has a cross shape or crossing radial portions. For these examples, basically, that a plurality of “internal elements” are generated must be taken into consideration.

As described above, to generate neutral plane shell elements by generating tetrahedral elements in a three-dimensional shape such that the number of divided layers in the direction of plate thickness becomes one, the neutral plane shell elements are generated by making remark on the above-described “corner elements” and “internal elements”. This method will be described next in detail.

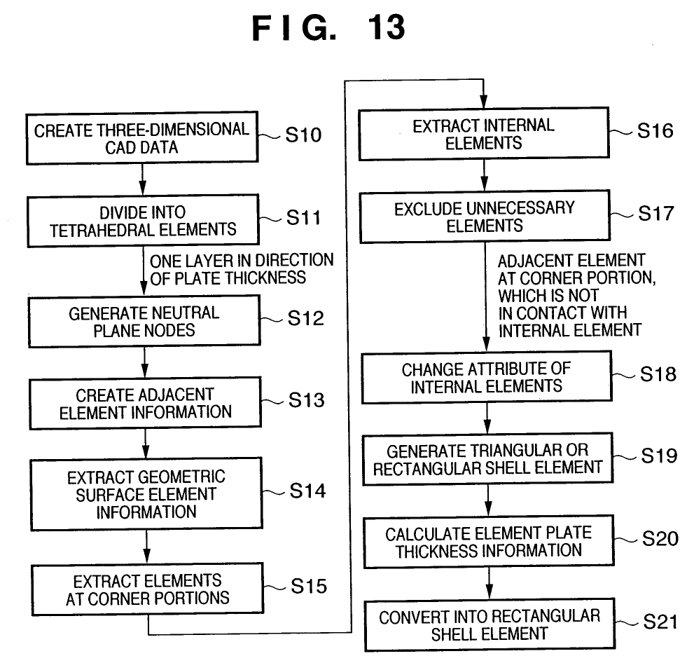

FIG. 13 is a flow chart for explaining the above-described flow shown in FIG. 1 in more detail. FIG. 13 shows a detailed flow to generate a neutral plane shell element from a generated tetrahedral element.

First, as shown in step S10 in FIG. 13, assume that an object shape is designed by three-dimensional CAD so that three-dimensional CAD geometric data is available. As described above, processing starts from a state wherein the three-dimensional geometric data is loaded by a preprocessor such as IDEAS available from EDS PLM solutions or PATRAN available from MSC, which is used for finite element analysis and is capable of tetrahedral element division.

In step S11, tetrahedral elements are generated from the shape by using the automatic tetrahedral element division function of the preprocessor. At this time, the length of one side of each tetrahedral element must be designated such that the shape is divided in the direction of plate thickness to form a single-layered structure. This can be done by designating the maximum plate thickness of the shape. The node coordinate information and element constituent node information of the tetrahedral elements generated by element division are written in external files. If the shape has a thick-walled portion, and the number of layers in the direction of plate thickness should be two or more, the shape is corrected in advance on the three-dimensional CAD side.

In step S12, on the basis of the node coordinate information and element constituent node information of the tetrahedral elements generated in step S11, an intermediate node is generated in each of sides that constitute a tetrahedral element. This processing may be executed even by designating secondary tetrahedral elements (tetrahedrons having an intermediate node in each side) in automatic tetrahedral element division in step S11.

In step S13, for all the divided tetrahedral elements, a table of the numbers of elements that are adjacent to the planes of the tetrahedral elements is created. In step S14, for all the divided tetrahedral elements, a table of planes that are not adjacent to the planes of the tetrahedral elements (i.e., planes that constitute the surfaces of the shape) is created. These tables can easily be created.

In step S15, a “corner element” as a tetrahedral element whose two or more element planes are located on the outer surface of the shape is detected by determining each element of the shape. In step S16, an “internal element” as a tetrahedral element whose element planes are not located on the outer surface of the shape at all is detected. The “corner elements” and “internal elements” can also easily be detected.

In step S17, “corner elements” that are unnecessary for neutral plane shell element generation in the geometric data divided into the tetrahedral elements are excluded. As already described above in the example of the plate step portion shown in FIG. 5, the “corner element” at the plate step portion is excluded. However, a “corner element” at an end portion of the shape cannot be omitted. Hence, the two types of corner elements must be distinguished. To do this, a “corner element” adjacent to an “internal element” is extracted first. An element to be excluded can be decided by determining whether two or more element planes of the extracted “corner element” belong to the geometric surface constituent element table created in step S14. In step S18, the element is excluded, and the adjacent element information of “internal elements” is updated.

After this preparation, in step S19, triangular or rectangular neutral plane shell elements are generated in the direction of plate thickness of the shape by using the intermediate node information in step S12. When the tetrahedral elements are generated such that the number of layers formed by dividing the shape in the direction of plate thickness becomes one, a tetrahedral element generated between the upper and lower planes in the direction of plate thickness can basically take two forms. As the first form, a plane and a corresponding apex of the tetrahedral element are located on the upper and lower planes of the shape, as shown in FIG. 2. As the second form, two sides of the tetrahedral element are located on the upper and lower planes of the shape, as shown in FIG. 3. The neutral plane shell element is triangular in the former case and rectangular in the latter case.

In step S20, for each of the triangular or rectangular neutral plane shell elements generated in step S19, the plate thickness until the geometric surface in the direction of normal of the neutral plane shell element is calculated and defined as the plate thickness of the shell element. In step S21, it is checked whether, in all the triangles generated in step S19, two adjacent triangles can be converted into a rectangle, by considering the internal angles on both sides of the adjacent sides of the two triangles. If the two triangles can be converted into a rectangle, conversion is performed.

After the above operation, analysis input data is created by adding boundary conditions or analysis conditions corresponding to the type of analysis to the node coordinates, element constituent node, and element plate thickness information of the triangular or rectangular shell elements generated in accordance with the above-described procedures. Then, analysis is executed.

### Example

An example in which the above-described embodiment is applied to an actual product shape will be described next. Plastic injection molding CAE (filling/packing/cooling/warp analysis program)will be exemplified here, in which a thin-walled plastic structure exterior component is modeled by shell elements and analyzed.

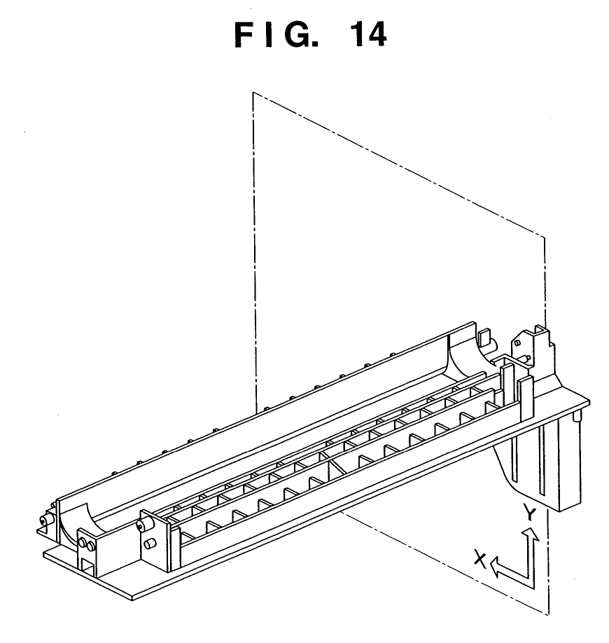

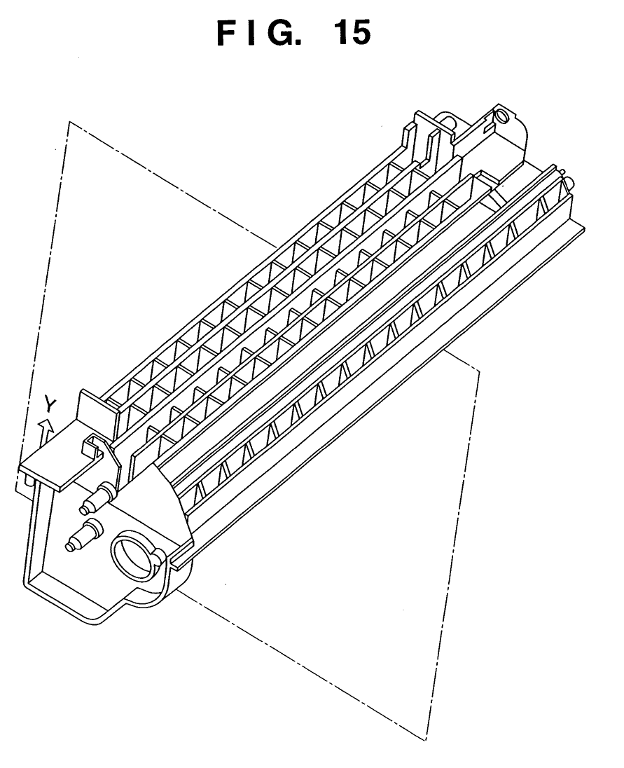

FIGS. 14 and 15 show the three-dimensional CAD geometric data of a component of a fixing toner container used in a laser beam printer (LBP), which is designed by IDEAS. The basic plate thickness of this component is 2.5 mm. The component has a complex rib shape.

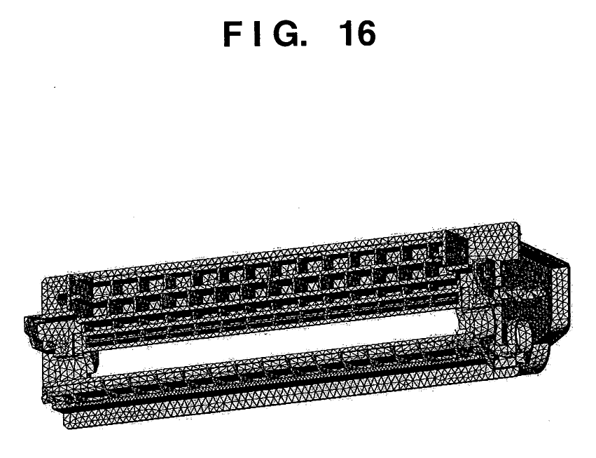

FIG. 16 is a view showing divided elements obtained by automatically dividing the three-dimensional CAD geometric data into tetrahedral elements by using a preprocessor function for finite element analysis of IDEAS so as to form a single-layered structure in the direction of plate thickness. This view of divided elements is output to a universal file (text data) as the intermediate format file of IDEAS.

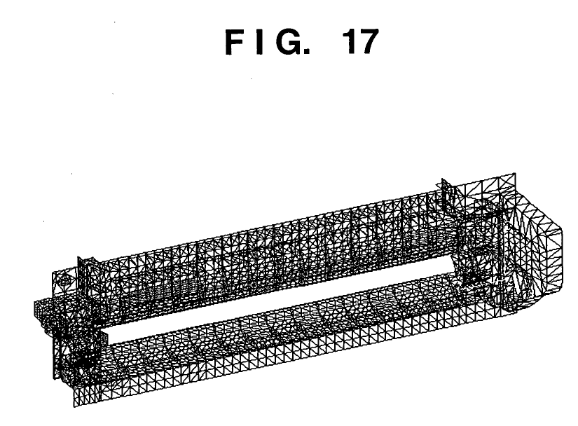

FIG. 17 shows a final shell element model for which the universal file is loaded, and neutral plane shell elements are generated from the tetrahedral elements on the basis of the above-described neutral plane element division method. The time until the final neutral plane shell elements are generated from the three-dimensional CAD geometric data is about 30 min in a PC having a CPU speed of 1 GHz.

When analysis input data is created by adding boundary conditions or analysis conditions corresponding to the type of analysis to the geometric model, injection molding analysis can be executed.

As described above, according to the above embodiment, a shell element analytical model can be automatically created on the basis of three-dimensional CAD geometric data, unlike the conventional method of manually generating a neutral plane shell element or shell element. Accordingly, the time of shell element analytical model creation from three-dimensional CAD geometric data can largely be shortened.

As many apparently widely different embodiments of the present invention can be made without departing from the spirit and scope thereof, it is to be understood that the invention is not limited to the specific embodiments thereof except as defined in the appended claims.

What is claimed is:

1. An analytical model conversion method of converting a three-dimensional analytical model into a two-dimensional analytical model, comprising generating tetrahedral solid elements for an input three-dimensional geometric model, and connecting intermediate nodes of sides that extend in a direction of plate thickness in each tetrahedral solid element to generate a triangular or rectangular shell element.

2. The method according to claim 1, wherein the three-dimensional shape is a shape having a thin-walled structure, and tetrahedral elements having a single-layered structure are generated in the direction of plate thickness.

3. The method according to claim 1, wherein a plate thickness of the three-dimensional shape is calculated, and plate thickness information is added to the triangular or rectangular shell element as a neutral plane element.

4. The method according to claim 1, wherein for the triangular shell element, two adjacent triangular shell elements are converted into a rectangular shell element as needed.
